(19) United States
(12) Patent Application Publication
(10) Pub. No.: US 2023/0019425 A1
(43) Pub. Date: Jan. 19, 2023

(54) ANTENNA DEVICE AND ELECTRONIC DEVICE

(71) Applicant: Guangdong Oppo Mobile Telecommunications Corp., Ltd., Dongguan (CN)

(72) Inventor: Zhengdong YONG, Dongguan (CN)

(73) Assignee: Guangdong Oppo Mobile Telecommunications Corp., Ltd., Dongguan (CN)

(21) Appl. No.: 17/947,788

(22) Filed: Sep. 19, 2022

Related U.S. Application Data
(63) Continuation of application No. PCT/CN2021/074780, filed on Feb. 2, 2021.

(30) Foreign Application Priority Data
Mar. 19, 2020 (CN) 202010195147.6

(51) Int. Cl. H01Q 9/04; H01Q 5/335

(52) U.S. Cl. CPC H01Q 9/0414; H01Q 5/335

(57) ABSTRACT

An antenna device and an electronic device are provided. The antenna apparatus includes a dielectric substrate, a grounding metal layer, a radiation patch, a first feeding structure, a first deflection patch, and a radio frequency chip. The grounding metal layer, the dielectric substrate, and the radiation patch are stacked. The first feeding structure has a first end connected to the radiation patch, and a second end electrically connected to the radio frequency chip. The radio frequency chip is configured to feed a first excitation signal to the first feeding structure to excite the radiation patch to radiate beam. The first deflection patch is fixed on a side of dielectric substrate away from the grounding metal layer, the first deflection patch is located at a side of the radiation patch, and is configured to be in an amorphous state or in a crystalline state when the antenna device works.

### CROSS-REFERENCE TO RELATED APPLICATIONS

This application is a continuation application of International Application No. PCT/CN2021/074780, filed on Feb. 2, 2021, which claims priority to Chinese Patent Application No. 202010195147.6, filed on Mar. 19, 2020, the entire disclosure of which are incorporated herein by reference.

### TECHNICAL FIELD

The present application relates to the field of antenna technology, and in particular to an antenna device and an electronic device.

### BACKGROUND

During the use of electronic devices, in order to ensure antenna performance of the electronic device, the antenna device is fixedly installed. Due to the fixed arrangement of the antenna device, the radiation direction of the beam of the antenna device is fixed.

### SUMMARY

The application provides an antenna device and an electronic device. The technical solution is as follows:

In one aspect, an antenna device includes a dielectric substrate, a grounding metal layer, a radiation patch, a first feeding structure, a first deflection patch, and a radio frequency chip. The grounding metal layer, the dielectric substrate, and the radiation patch are stacked; the first feeding structure penetrates through the dielectric substrate; a first end of the first feeding structure is connected to the radiation patch, and a second end of the first feeding structure extends through the grounding metal layer, and is electrically connected to the radio frequency chip; a first gap is formed between the first feeding structure and the grounding metal layer, the radio frequency chip is configured to feed a first excitation signal to the first feeding structure to excite the radiation patch to radiate beam. The first deflection patch is fixed on a side of dielectric substrate away from the grounding metal layer, the first deflection patch is located at a side of the radiation patch, the first deflection patch is configured to be in an amorphous state or in a crystalline state when the antenna device works.

Another aspect provides an electronic device, the electronic device includes a controller and the antenna device as described above, and the controller is used to control the first deflection patch to be converted from an amorphous state to a crystalline state, or from a crystalline state to an amorphous state.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

In order to more clearly describe the technical solution in the embodiments of the present application, the following will be briefly introduce the drawings that need to be used in the description of the embodiments. Apparently, the drawings in the following description are only some embodiments of the present application. For those of ordinary skill in the art, other drawings can be obtained in accordance with these drawings without creative labor.

FIG. 1 is a schematic view of a top view structure of an antenna device provided in embodiments of the present application.

FIG. 2 is a schematic view of a cross-sectional view of the antenna device in FIG. 1 taken along a line A-A.

FIG. 3 is a schematic view of a beam radiation direction when a first deflection patch is in a crystalline state provided in embodiments of the present application.

FIG. 4 is a schematic view of a beam radiation direction when a first deflection patch is in an amorphous state provided in embodiments of the present application.

FIG. 5 is a schematic view of beam scanning of an antenna array composed of an antenna device provided in embodiments of the present application.

FIG. 6 is a schematic structural view of a radiation patch provided in embodiments of the present application.

FIG. 7 is a schematic structural view of a radiation patch provided in other embodiments of the present application.

FIG. 8 is a schematic structural view of a radiation patch provided in other embodiments of the present application.

FIG. 9 is a schematic structural view of a radiation patch provided in other embodiments of the present application.

FIG. 10 is a schematic structural view of a radiation patch provided in other embodiments of the present application.

FIG. 11 is a schematic structural view of an antenna device provided in other embodiments of the present application.

FIG. 12 is a schematic view of a top view structure of an antenna device provided in other embodiments of the present application.

FIG. 13 is a schematic view of a cross-sectional view of the antenna device taken along a line B-B.

FIG. 14 is a schematic view of beam scanning of an antenna array composed of an antenna device provided in other embodiments of the present application.

FIG. 15 is a schematic view of beam scanning of an antenna array composed of an antenna device provided in other embodiments of the present application.

FIG. 16 is a schematic view of a top view structure of an antenna device provided in other embodiments of the present application.

FIG. 17 is a schematic view of a cross-sectional view of the antenna device in FIG. 16 taken along a line C-C.

FIG. 18 is a schematic structural view of an electronic device provided in embodiments of the present application.

### DETAILED DESCRIPTION

In order to make the purpose, technical solutions and advantages of the present application clear, the present application will be further described in detail below with reference to the accompanying drawings.

The present disclosure provides an antenna device includes a dielectric substrate, a grounding metal layer, a radiation patch, a first feeding structure, a first deflection patch, and a radio frequency chip.

The grounding metal layer, the dielectric substrate, and the radiation patch are stacked, the first feeding structure penetrates through the dielectric substrate, the first end of the first feeding structure is connected to the radiation patch, and the second end of the first feeding structure extends through the grounding metal layer, and is electrically connected to the radio frequency chip, a first gap is formed between the first feeding structure and the grounding metal layer, and the radio frequency chip is used to feed a first excitation signal to the first feeding structure, and the first excitation signal is used to excite the radiation patch radiate beam.

The first deflection patch is fixed on the side of the first substrate layer of the dielectric substrate away from the grounding metal layer, the first deflection patch is located on the first side of the radiation patch, the first deflection patch can be converted from an amorphous state to a crystalline state, or from a crystalline state to an amorphous state, and the first substrate layer of the dielectric substrate is any one of the at least one dielectric substrate.

In an embodiment, when the first deflection patch is in a crystalline state, the beam radiated by the radiation patch is deflected to the first side of the radiation patch.

In an embodiment, when the first deflection patch is in an amorphous state, the beam radiated by the radiation patch radiation does not deflect.

In an embodiment, the first deflection patch achieves conversion between the crystalline state and the amorphous states under the action of temperature or laser.

In an embodiment, the antenna device further includes a first conductive structure.

The first conductive structure penetrates through the dielectric substrate, and the first end of the first conductive structure is connected to the first deflection patch, and the second end of the first conductive structure extends through the grounding metal layer, and is electrically connected to an external circuit, the first conductive structure is insulated from the grounding metal layer, the external circuit is used to feed a first electrical signal to the first conductive structure, the first electrical signal is used to excite the first deflection patch from an amorphous state to a crystalline state, or from a crystalline state to an amorphous state.

In an embodiment, the distance between the radiation patch and the first deflection patch is greater than or equal to 0.2 mm and less than or equal to 2 mm.

In an embodiment, the antenna device further includes a second deflection patch.

The second deflection patch is fixed on the side of the first substrate layer of the dielectric substrate away from the grounding metal layer.

The second deflection patch is located on the second side of the radiation patch opposite to the first side, the second deflection patch can be converted from an amorphous state to a crystalline state, or from a crystalline state to an amorphous state.

In an embodiment, the antenna device further includes a second deflection patch.

The second deflection patch is fixed on the side of the second substrate layer of the dielectric substrate away from the grounding metal layer.

The second deflection patch is located on the second side of the radiation patch opposite to the first side, the second deflection patch can be converted from an amorphous state to a crystalline state, or from a crystalline state to an amorphous state. The second substrate layer of the dielectric substrate is a substrate layer of the dielectric substrate which is different from the first substrate layer of the dielectric substrate in the dielectric substrate.

In an embodiment, the antenna device further includes a second feeding structure.

The second feeding structure penetrates through the dielectric substrate, the first end of the second feeding structure is electrically connected to the radiation patch, and the second end of the second feeding structure extends through the grounding metal layer, and is electrically connected to the radio frequency chip, a second gap is formed between the second feeding structure and the grounding metal layer, and the radio frequency chip is used to feed a second excitation signal to the second feeding structure, and the second excitation signal is used to excite the radiation patch radiation beam.

In an embodiment, the antenna device further includes a third deflection patch.

When the second deflection patch is fixed on the side of the first substrate layer of the dielectric substrate away from the grounding metal layer, the third deflection patch is fixed on the side of the first substrate layer of the dielectric substrate or the third layer of the dielectric away from the grounded metal layer. The third substrate layer of the dielectric substrate is a substrate layer of the dielectric substrate which is different from the first substrate layer of the dielectric substrate in the dielectric substrate.

The third deflection patch is located on the third side of the radiation patch adjacent to the first side, and the third deflection patch can be converted from an amorphous state to a crystalline state, or from a crystalline state to an amorphous state.

In an embodiment, the antenna device further includes a fourth deflection patch.

When the third deflection patch is fixed on the side of the first substrate layer of the dielectric substrate away from the grounding metal layer, the fourth deflection patch is fixed on the side of the first substrate layer of the dielectric substrate or the fourth substrate layer of the dielectric substrate away from the grounded metal layer. The fourth substrate layer of the dielectric substrate is a substrate layer of the dielectric substrate which is different from the first substrate layer of the dielectric substrate in the dielectric substrate.

The fourth deflection patch is located on the fourth side of the radiation patch opposite the third side, the fourth deflection patch can be converted from an amorphous state to a crystalline state.

In an embodiment, the antenna device further includes a fourth deflection patch.

When the third deflection patch is fixed on the side of the third substrate layer of the dielectric substrate away from the grounding metal layer, the fourth deflection patch is fixed on the side of the third substrate layer of the dielectric substrate away from the grounding metal layer.

The fourth deflection patch is located on the fourth side of the radiation patch opposite the third side, the fourth deflection patch can be converted from an amorphous state to a crystalline state.

In an embodiment, the antenna device further includes a third deflection patch.

When the second deflection patch is fixed on the side of the second substrate layer of the dielectric substrate away from the grounding metal layer, the third deflection patch is fixed on the side of the first substrate layer of the dielectric substrate or the third substrate layer of the dielectric substrate away from the grounded metal layer. The third substrate layer of the dielectric substrate is a substrate layer of the dielectric substrate which is different from the first substrate layer of the dielectric substrate and the second substrate layer of the dielectric substrate in the dielectric substrate.

The third deflection patch is located on the third side of the radiation patch adjacent to the first side, and the third deflection patch can be converted from an amorphous state to a crystalline state, or from a crystalline state to an amorphous state.

In an embodiment, the antenna device further includes a fourth deflection patch.

When the third deflection patch is fixed on the side of the first substrate layer of the dielectric substrate away from the grounding metal layer, the fourth deflection patch is fixed on side of the second substrate layer of the dielectric substrate away from the grounding metal layer.

The fourth deflection patch is located on the fourth side of the radiation patch opposite the third side, the fourth deflection patch can be converted from an amorphous state to a crystalline state.

In an embodiment, the antenna device further includes a fourth deflection patch.

When the third deflection patch is fixed on the side of the third substrate layer of the dielectric substrate away from the grounding metal layer, the fourth deflection patch is fixed on the side of the first substrate layer of the dielectric substrate, the third substrate layer of the dielectric substrate or the fourth substrate layer of the dielectric substrate away from the grounded metal layer. The fourth substrate layer of the dielectric substrate is a substrate layer of the dielectric substrate which is different from the first substrate layer of the dielectric substrate, the second substrate layer of the dielectric substrate and the third substrate layer of the dielectric substrate in the dielectric substrate.

The fourth deflection patch is located on the fourth side of the radiation patch opposite the third side, the fourth deflection patch can be converted from an amorphous state to a crystalline state.

In an embodiment, the radiation patch includes two or more radiation sub-patches, the sub-radiation patches are stacked, the shape and size of each radiation sub-patch are different from that of the others, or, the shape or size of each radiation sub-patch are different from that of the others.

In an embodiment, the radiation sub-patch has a rectangular or circular structure.

In an embodiment, the antenna device is a side-fire antenna or an end-fire antenna.

In an embodiment, the antenna device comprises a single antenna element or an antenna array.

An embodiment of the present application provides an electronic device, the electronic device includes a controller and the antenna device which is illustrated in any of the above embodiments. And the controller is used to control the first deflection patch to be converted from an amorphous state to a crystalline state, or from a crystalline state to an amorphous state.

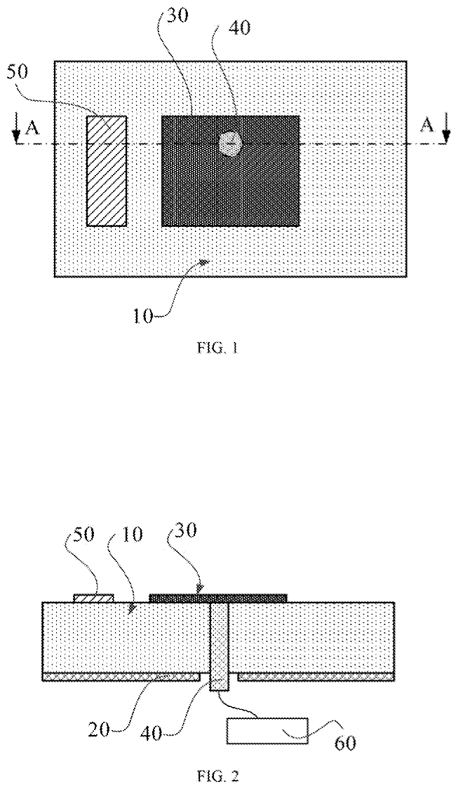

FIG. 1 illustrates a schematic view of a top view structure of an antenna device provided in embodiments of the present application, and FIG. 2 illustrates a schematic view of an A-A cross-sectional view of an antenna device provided in embodiments of the present application. As shown in FIG. 1 and FIG. 2, the antenna device includes a dielectric substrate 10, a grounding metal layer 20, a radiation patch 30, a first feeding structure 40, a first deflection patch 50, and a radio frequency chip 60. The dielectric substrate 10 may include at least one substrate layer, that is to say, the dielectric substrate 10 may include one substrate layer, two substrate layers, three substrate layers, or more than three substrate layers. The dielectric substrate 10 includes a first side and a second side opposite to the first side. The grounding metal layer 20, the dielectric substrate 10 and the radiation patch 30 are stacked. The grounding metal layer 20 is attached to the second side of the dielectric substrate 10. The radiation patch 30 is attached to the first side of the dielectric substrate 10. The first feeding structure 40 penetrates through the dielectric substrate 10. The first end of the first feeding structure 40 is connected to the radiation patch 30, which defines a first connection point between the first feeding structure 40 and the radiation patch 30. The second end of the first feeding structure 40 extends through the grounding metal layer 20, and is electrically connected to the radio frequency chip 60. A first gap is formed between the first feeding structure 40 and the grounding metal layer 20. The radio frequency chip 60 is used to feed a first excitation signal to the first feeding structure 40, and the first excitation signal is used to excite the radiation patch 30 to radiate beam. The first deflection patch 50 is fixed at the first side of the dielectric substrate 10 away from the grounding metal layer 20. The first deflection patch 50 is positioned at a first side of the radiation patch 30. The first deflection patch 50 can be converted from an amorphous state to a crystalline state, or from a crystalline state to an amorphous state.

In the embodiment of the present application, the first excitation signal can be fed through the first feeding structure 40, and then the radiation patch 30 can be excited by the first excitation signal to radiate the beam, so as to implement the basic function of the antenna device. Alternatively, since the first deflection patch 50 can be converted from a crystalline state (metal state) to an amorphous state (insulating state), or from an amorphous state (insulating state) to a crystalline state (metal state), so that when the radiation patch 30 radiates beam, the first deflection patch 50 can be controlled to be in different states, that is, the first deflection patch 50 can be controlled to be in a crystalline state, or the first deflection patch 50 can be controlled to be in an amorphous state, so as to implement the deflection of the radiation direction of the beam, thus achieving the adjustment of the radiation direction of the beam, improves the spatial coverage of the antenna device.

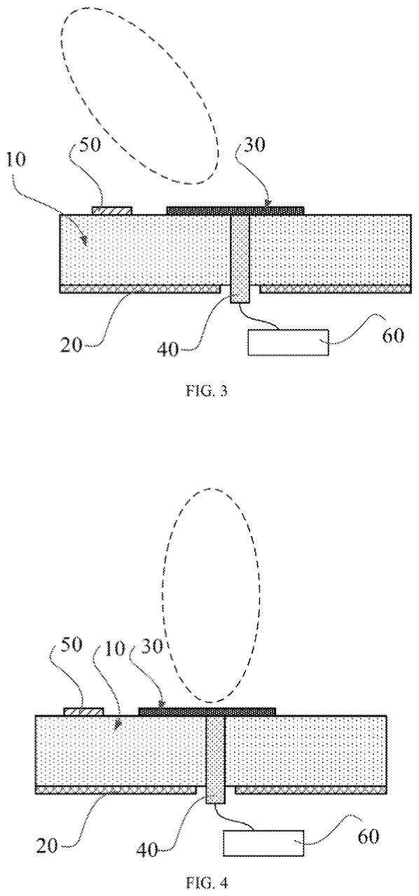

In operation, when the first deflection patch 50 is controlled to be in the crystalline state, the radiation direction of the beam radiated by the radiation patch 30 excited by the first excitation signal can be deflected to one side of the first deflection patch 50. When the first deflection patch 50 is controlled to be in the amorphous state, the radiation direction of the beam radiated by the radiation patch 30 excited by the first excitation signal will not be deflected. That is, as shown in FIG. 3, when the first deflection patch 50 is in the crystalline state, the beam radiated by the radiation patch 30 is deflected to the first side of the radiation patch 30, as shown in FIG. 4, when the first deflection patch 50 is in the amorphous state, the beam radiated by the radiation patch 30 does not occur deflection. In this way, the adjustment of multiple radiation directions of the beam of the antenna device can be implemented under different requirements.

The first connection point between the first feeding structure 40 and the radiation patch 30 may be located on the center line of the radiation patch 30, and a distance between the first connection point and the center point of the radiation patch 30 may be located within a first distance threshold range, the first distance threshold range refers to a distance range used to adjust impedance matching. That is, the impedance of the antenna device can be adjusted by adjusting the distance between the first connection point and the center point of the radiating patch 30, and then the antenna matching of the antenna device can be implemented to increase radiation efficiency of the antenna device. The first connection point can be located on the center line of the radiation patch 30 parallel to the length direction of the first deflection patch 50. Obviously, the first connection point can also be slightly offset from center line of the radiation patch 30 parallel to the length direction of the first deflection patch 50, which is not limited in the present application.

Illustratively, the distance between the first connection point and the center point of the radiation patch 30 can be adjusted so that the impedance of the antenna device is 4 ohms, 5 ohms, or 6 ohms. The present application does not limit the impedance of the antenna device after adjustment.

In some embodiments, the antenna device, including the dielectric substrate 10, the grounded metal layer 20, the radiation patch 30, and the first feeding structure 40, may be a side-fire antenna or an end-fire antenna, such as a dipole antenna etc. In addition, the antenna device, including the dielectric substrate 10, the grounded metal layer 20, the radiation patch 30, and the first feeding structure 40, may be a single antenna unit or an antenna array. That is, the antenna device, including the dielectric substrate 10, the grounded metal layer 20, the radiation patch 30, and the first feeding structure 40, can be arranged in a matrix structure to obtain an antenna array. The implementation form of the antenna device, including the dielectric substrate 10, the grounded metal layer 20, the radiation patch 30 and the first feeding structure 40, is not limited in the present application.

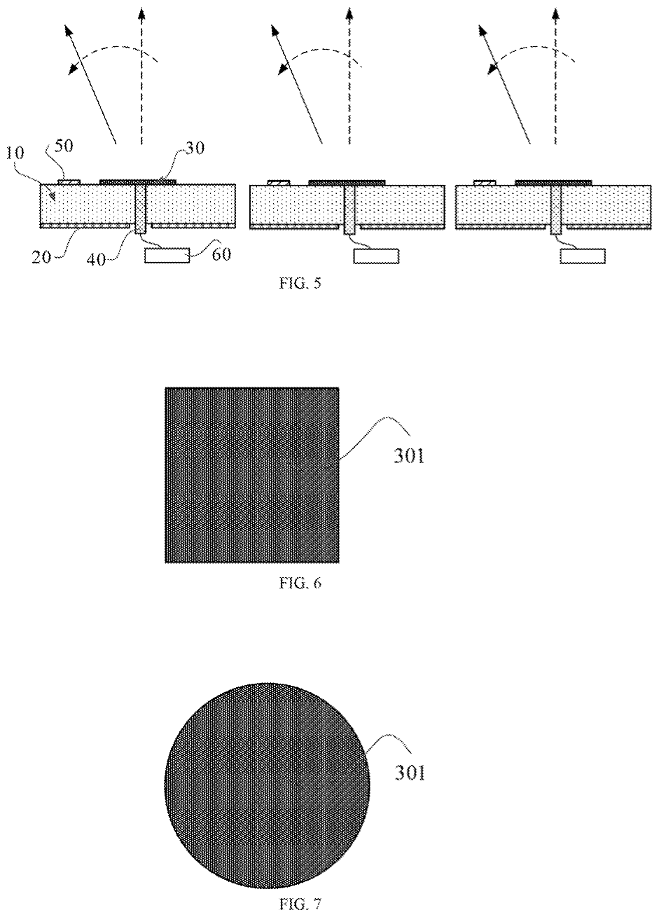

In some embodiments, because the beam radiation direction of the antenna device can be adjusted, the array antenna formed by the antenna device can not only realize the general performance of the antenna, but also realize the performance of beam scanning. Wherein, when the antenna device includes the dielectric substrate 10, the grounded metal layer 20, the radiation patch 30, the first feeding structure 40 and the first deflection patch 50, the first deflection patch 50 can be controlled to convert from an amorphous state to a crystalline state, and the beam scanning is realized by the antenna array formed by the antenna device, and the beam scanning diagram can be as shown in FIG. 5.

In some embodiments, the radiation patch 30 may include at least one radiation sub-patch. When the radiation patch 30 includes two or more radiation sub-patches 301, the radiation sub-patches 301 are stacked, the shape and size of each radiation sub-patch 301 are different from that of the others, or, the shape or size of each radiation sub-patch 301 is different from that of the others. Since each radiation sub-patch 301 has a different shape and size, or, each radiation sub-patch 301 has a different shape or size, when the radiation sub-patches 301 are stacked and arranged, different bandwidths corresponding to each radiation sub-patch 301 and mutual coupling between two radiation sub-patches 301 can increase the overall bandwidth of the radiation patch 30, thereby increasing the bandwidth of the antenna device.

FIG. 6 and FIG. 7 illustrate some embodiments of the radiation sub-patch 301, the radiation sub-patch 301 may have a rectangular or circular structure.

When the radiation sub-patch 301 has a rectangular structure, the length direction of the first deflection patch 50 is parallel to the first side of the radiation sub-patch 301, wherein the first side edge of the radiation sub-patch is an edge of the radiation sub-patch adjacent to the first deflection patch 50. In some alternative embodiments, the length direction of the first deflection patch 50 and the adjacent first side of the radiation sub-patch 301 may define a certain angle.

When the sub-radiating patch 301 has a circular structure, the length directions of the first deflection patch 50 and the radiation sub-patch 301 are located on the same plane.

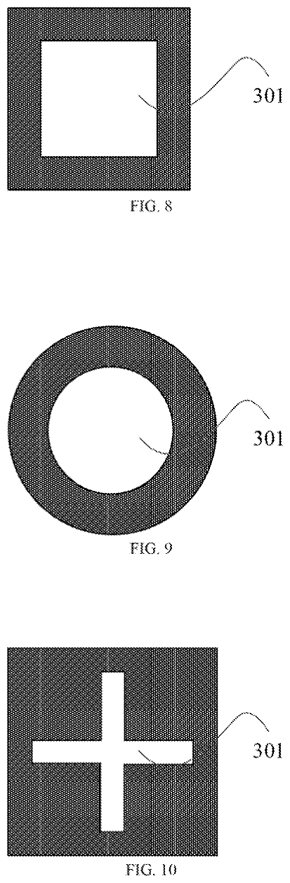

For example, the radiation sub-patch 301 may be a whole-piece structure, obviously, it also be a sheet-like structure provided with through holes. For example, as shown in FIG. 8, the radiation sub-patch 301 may be a rectangular ring structure, or as shown in FIG. 9, the radiation sub-patch 301 may be a circular ring structure, or as shown in FIG. 10, the radiation sub-patch 301 may be a rectangular structure provided with a cross-shaped through hole or the like.

In an embodiment, as shown in FIG. 1, the first deflection patch 50 may be a striped rectangular structure, and the first deflection patch 50 may be formed by a reversible phase change material. For example, the phase change material may be vanadium dioxide, germanium antimony tellurium alloy, scandium antimony tellurium alloy or germanium antimony alloy, etc.

In some embodiments, the first deflection patch 50 and the radiation patch 30 may be located on different substrate layers of the dielectric substrate 10, that is, dielectric substrate 10 may include a first substrate layer and a second substrate layer, at this time, the first deflection patch 50 is fixed on the first substrate layer of the dielectric substrate, and the radiation patch layer 30 is fixed on the second substrate layer of the dielectric substrate; or the first deflection patch 50 is fixed on the second substrate layer of the dielectric substrate, and the radiation patch 30 is fixed on the first substrate layer of the dielectric substrate.

In some embodiments, the first deflection patch 50 and the radiation patch 30 may be located on same substrate layer of the dielectric substrate, that is, the first deflection patch 50 and the radiation patch 30 are located at the same plane. In this way, the deflection effect of the first deflection patch 50 on the direction of the beam of the radiation patch 30 can be better improved.

For example, when the distance between the first deflection patch 50 and the radiation patch 30 approaches zero, the radiation patch 30 and the first deflection patch 50 can be approximated as one piece so that the deflection of the beam radiation direction cannot be achieved; when the distance between the first deflection patch 50 and the radiation patch 30 approaches infinity, it is equivalent to the absence of the first deflection patch 50, so that the deflection of the beam radiation direction cannot be achieved. Therefore, the distance between the first deflection patch 50 and the radiation patch 30 is within a certain range, so as to better realize the deflection of the beam direction radiated by the radiation patch 30. Wherein, the distance between the radiation patch 30 and the first deflection patch 50 may be in a range of about 0.2 mm to about 2 mm.

In some embodiments, the first deflection patch 50 can switch between the crystalline state and the amorphous state under the action of temperature, obviously, it can also switch between the crystalline state and the amorphous in other ways, such as under the action of laser excitation, the crystalline state and the amorphous state can be switched.

When the state is switched by the effect of temperature, as shown in FIG. 11, the antenna device may further include a first conductive structure 70, and the first conductive structure 70 penetrates through the dielectric substrate 10, the first end of the first conductive structure 70 is connected to the first deflection patch 50, and the second end of the first conductive structure 70 extends through the grounding metal layer 20, and is electrically connected to an external circuit, the first conductive structure 70 is insulated from the grounding metal layer 20, and the external circuit is used to feed a first electrical signal to the first conductive structure 70, the first electrical signal is used to excite the first deflection patch 50 from an amorphous state to a crystalline state, or from a crystalline state to an amorphous state.

In operation, when the first deflection patch 50 is converted between the two states, assuming that the first deflection patch 50 is currently in the crystalline state, the first reflection patch 50 can be excited by the first electrical signal to heat up, when the temperature of the deflection patch 50 is not less than the temperature threshold, the excitation of the first electrical signal is stopped to achieve the rapid cooling of the first deflection patch 50, so that the first deflection patch 50 is switched to the amorphous state. And, assuming that the first deflection patch 50 is currently in the amorphous state, the rust reflection patch 50 can be excited by the first electrical signal to heat up, when the temperature of the first deflection patch 50 is not less than the temperature threshold, the first electrical signal is slowly reduced to achieve the slow cooling of the first deflection patch 50, so that the first deflection patch 50 is switched to the crystalline state.

Wherein, the temperature threshold may be determined based on the material of the first deflection patch 50, and the temperature threshold refers to the temperature at which the crystal grains inside the first deflection patch 50 can be in a free state.

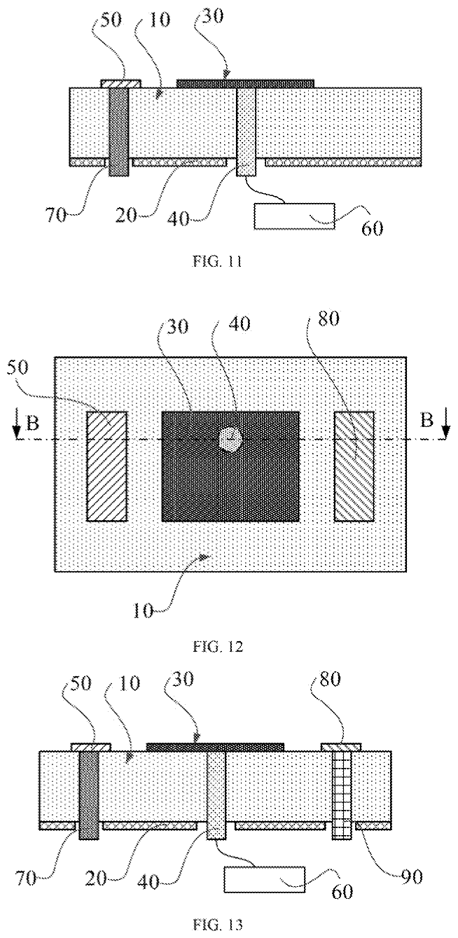

In an embodiment, as shown in FIG. 12, the antenna device may further include a second deflection patch 80. The second deflection patch 80 is located on a second side of the radiation patch 30 opposite to the first side of the radiation patch 30, and the second deflection patch 80 can be converted from an amorphous state to a crystalline state, or from a crystalline state to an amorphous state.

Wherein, the second deflection patch 80 is fixed on the first side of the first substrate layer of the dielectric substrate 10 away from the grounding metal layer 20. The first deflection patch 50 and the second deflection patch 80 can be located on the same substrate layer of the dielectric substrate. Alternatively, the first deflection patch 50 and the second deflection patch 80 can be located on the different substrate layers of the dielectric substrate 10, for example, the first deflection patch 50 is fixed on the first substrate layer, and the second deflection patch 80 is fixed on the second substrate layer of the dielectric substrate 10 away from the grounding metal layer 20, the second substrate layer of the dielectric substrate is a substrate layer of the dielectric substrate 10 which is different from the first substrate layer of the dielectric substrate 10.

Wherein, the material of the second deflection patch 80 and the material of the first deflection patch 50 may be the same or similar. In some embodiments, the setting position of the second deflection patch 80 at the second side of the radiation patch 30 may be substantially corresponding to the setting position of the first deflection patch 50 at the first side of the radiation patch 30. This will not be repeated in the application embodiments.

Wherein, the first substrate layer of the dielectric substrate may be located above the second substrate layer of the dielectric substrate, or may be located below the second substrate layer of the dielectric substrate, which is not limited in the embodiment of the present application. When the first deflection patch 50 and the second deflection patch 80 are both located on the first substrate layer of the dielectric substrate, it can be considered that the first deflection patch 50 and the second deflection patch 80 are arranged in the same layer, when the first deflection patch 50 is located on the first substrate layer of the dielectric substrate and the second deflection patch 80 is located on the second substrate layer of the dielectric substrate, it can be considered that the first deflection patch 50 and the second deflection patch 80 are arranged in different layers. In addition, the radiation patch 30 may be provided in the same layer as the first deflection patch 50 and the second deflection patch 80, or may be provided in different layers, which is not limited in the embodiment of the present application.

Alternatively, when the reversible change between the crystalline state and the amorphous state of the second deflection patch 80 is achieved by temperature change, as shown in FIG. 13, the antenna device may further include a second conductive structure 90, and the location structure of the second conductive structure 90 may be the same or similar to that of the first conductive structure 70, which will not be repeated in the embodiment of the present application.

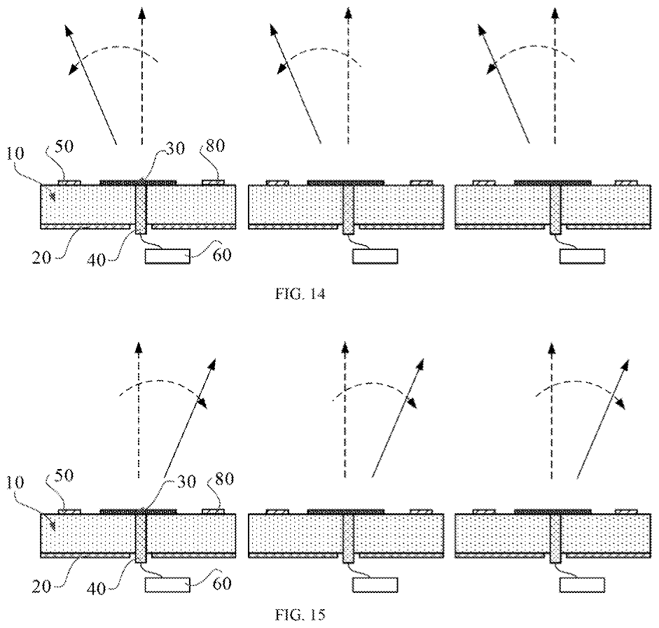

For example, when the antenna device includes the first deflection patch 50 and the second deflection patch 80, the first deflection patch 50 can be controlled to be converted from an amorphous state to a crystalline state, and the second deflection patch 80 can be controlled to be converted from a crystalline amorphous state to an amorphous state to achieve a beam scan by an antenna array of the antenna device, and the beam scanning diagram can be as shown in FIG. 14; or the first deflection patch 50 can be controlled to be converted from crystalline state to amorphous state, and the second deflection patch 80 is controlled to be converted from an amorphous state to a crystalline state to achieve a beam scan by an antenna array c of the antenna device, and the beam scanning diagram can be as shown in FIG. 15.

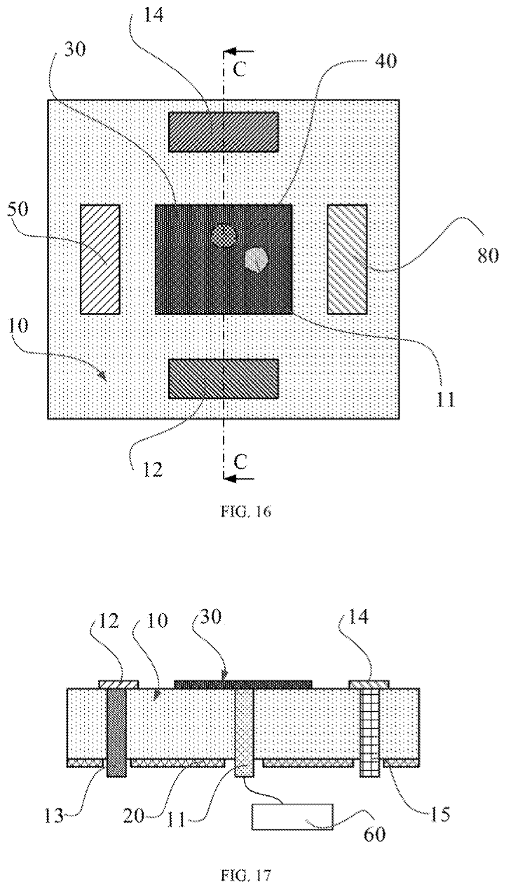

In some embodiments, as shown in FIG. 16 or FIG. 17, the antenna device may further include a second feeding structure 11, and the second feeding structure 11 penetrates through the dielectric substrate 10, and the first end of the second feeding structure 1I is electrically connected to the radiation patch 30, which defines a second connection point between the second feeding structure 40 and the radiation patch 30. The second end of the second feeding structure 11 extends through the grounding metal layer 20, and is electrically connected to the radio frequency chip 60. A second gap is formed between the second feeding structure 11 and the grounding metal layer 20, and the radio frequency chip 60 is used to feed a second excitation signal to the second feeding structure 11, and the second excitation signal is used to excite the radiation patch 30 to radiate radiation beam.

In this way, when the radio frequency chip 60 feeds the second excitation signal to the second feeding structure 11, the radiation patch 30 can be excited by the second excitation signal to radiate the directional beam, and the radio frequency chip 60 can feed the first excitation signal to the first feeding structure 40, under the influence of the first deflection patch 50, the feeding structure 40 excites the beam with adjustable radiation direction of the radiation patch 30 through the first excitation signal.

For example, the second feeding structure 11 may be provided when the antenna device includes the radiation patch 30 and the first deflection patch 50, or the second feeding structure 11 may be provided when the antenna device includes radiation patch 30, the first deflection patch 50 and the second deflection patch 80.

In an embodiment, illustrated in FIG. 16, a third deflection patch 12 may be further provided when the antenna device includes the radiation patch 30, the first deflection patch 50, and the second feeding structure 1. Alternatively, the third deflection patch 12 may also be provided when the antenna device includes the radiation patch 30, the first deflection patch 50, the second deflection patch 80, and the second feeding structure 11.

As shown in FIG. 16 or FIG. 17, the antenna device includes the third deflection patch 12, and the third deflection patch 12 is located at a third side of the radiation patch 30, the third side is between the first side and the second side of the radiation patch 30, and the third deflection patch 12 can be converted from an amorphous state to a crystalline state, or from a crystalline state to an amorphous state.

In some embodiments, when the second deflection patch 80 is fixed on the first side of the first substrate layer of the dielectric substrate away from the grounding metal layer 20, the third deflection patch 12 is fixed on the side of the first substrate layer of the dielectric substrate or the third substrate layer of the dielectric substrate away from the grounded metal layer 20, that is, the first deflection patch 50, the second deflection patch 80, and the third deflection patch 12 are located on the same substrate layer of the dielectric substrate, or the first deflection patch 50 and the second deflection patch 80 are located on the same substrate layer of the dielectric substrate, and the third deflection patch 12 is located on another layer of dielectric substrate.

In this way, when the second excitation signal is fed through the second feeding structure 11 excites the radiation beam of the radiation patch 30, the third deflection patch 12 can be controlled to be in different states, that is, the third deflection patch 12 can be controlled to be in a crystalline state, or the third deflection patch 12 can be controlled to be in an amorphous state, so as to implement the deflection of the radiation direction of the beam.

In the actual embodiment process, when the third deflection patch 12 is in the crystalline state, the radiation direction of the beam radiated by the radiation patch 30 excited by the second excitation signal can be deflected to towards the side where the third deflection patch 12 is located, that is, towards the third side of the third radiation patch; when the third deflection patch 12 is in the amorphous state, the radiation direction of the beam radiated by the radiation patch 30 excited by the second excitation signal will not be deflected. In this way, the adjustment of multiple radiation directions of the beam of the antenna device can be implemented under different requirements.

Wherein, the positional relationship between the first substrate layer of the dielectric substrate and the third substrate layer of the dielectric substrate may not be limited, and the first deflection patch 50, the second deflection patch 80, and the third deflection patch 12 may be located on the same substrate layer of the dielectric substrate or on the different substrate layers of the dielectric substrate based on the set position, which are not limited in the embodiment of the present application.

As shown in FIG. 16, the third deflection patch 12 may be a striped rectangular structure. The material of the third deflection patch 12 may be the same or similar to the material of the first deflection patch 50 described above, and the switching ways of the third deflection patch 12 between the crystalline state and the amorphous state can be referred to the above description, which will not be repeated in the embodiment of the present application.

In some embodiments, the third deflection patch 12 and the radiation patch 30 may be located on the different layers of the dielectric substrate, that is, dielectric substrate 10 comprises at least a third substrate layer of the dielectric substrate and a fourth substrate layer of the dielectric substrate. The third deflection patch 12 is fixed on the third substrate layer of the dielectric substrate, and the radiation patch 30 is fixed on the fourth substrate layer of the dielectric substrate; or the third deflection patch 12 is fixed on the fourth substrate layer of the dielectric substrate, and the radiation patch 30 is fixed on the third substrate layer of the dielectric substrate, etc.

Obviously, the third deflection patch 12 and the radiation patch 30 may be located on the same substrate layer of the dielectric substrate, that is, the third deflection patch 12 and the radiation patch 30 may be located on the same plane. In this way, the deflection of the direction of the beam radiated by the radiation patch 30 by the third deflection patch 12 can be better improved.

Alternatively, when the reversible change between the crystalline state and the amorphous state of the third deflection patch 12 is achieved by temperature change, as shown in FIG. 17, the antenna device may further include the third conductive structure 13, and the third conductive structure 13 penetrates through the dielectric substrate 10, the first end of the third conductive structure 13 is connected to the third deflection patch 12, and the second end of the third conductive structure 13 extends through the grounding metal layer 20, and is electrically connected to an external circuit, the third conductive structure 13 is insulated from the grounding metal layer 20, and the external circuit is used to feed a third electrical signal to the third conductive structure 13, the third electrical signal is used to excite the third deflection patch 12 from an amorphous state to a crystalline state, or from a crystalline state to an amorphous state.

Wherein, the third signal is used to excite the third deflection patch 12 from the amorphous state to the crystalline state, or from the crystalline state to the amorphous state, refer to the above mentioned the first deflection patch 50 is converted from the amorphous state to the realization state, or from the crystalline state to the amorphous state, which will not be repeated in the embodiment of the present application.

Alternatively, when the antenna device includes a second feeding structure 11 and a third deflection patch 12, as shown in FIG. 16 or FIG. 17, the antenna device may further include a fourth deflection patch 14. The fourth deflection patch 14 is located on a fourth side of the radiation patch 30 opposite to the third side of the radiation patch 30, and the fourth deflection patch 14 can be converted from the amorphous state to the crystalline state, or from the crystalline state to the amorphous state.

In some embodiments, when the third deflection patch 12 is fixed on the side of the first substrate layer of the dielectric substrate away from the grounding metal layer 20, the fourth deflection patch 14 is fixed on the side of the first substrate layer of the dielectric substrate or the fourth substrate layer of the dielectric substrate away from the grounded metal layer 20, that is, the first deflection patch 50, the second deflection patch 80, the third deflection patch 12, and the fourth deflection patch 14 are located on the same substrate layer of the dielectric substrate, or the first deflection patch 50, the second deflection patch 80, and the third deflection patch 12 are located on the same substrate layer of the dielectric substrate, and the fourth deflection patch 14 is located on another layer of dielectric substrate. The fourth dielectric substrate is one substrate layer of the dielectric substrate of at least one dielectric substrate 10 that is different from the first dielectric substrate.

In other embodiments, when the third deflection patch 12 is fixed on the side of the third substrate layer of the dielectric substrate away from the grounding metal layer 20, the fourth deflection patch 14 is fixed on the side of the third substrate layer of the dielectric substrate away from the grounding metal layer 20; that is, the first deflection patch 50 and the second deflection patch 80 are located on the same substrate layer of the dielectric substrate, and the third deflection patch 12 and the fourth deflection patch 14 are located on the same substrate layer of the dielectric substrate.

Wherein, the positional relationship between the first substrate layer of the dielectric substrate, the second substrate layer of the dielectric substrate, the third substrate layer of the dielectric substrate, and the fourth substrate layer of the dielectric substrate may not be limited, and the first deflection patch 50, the second deflection patch 80, the third deflection patch 12 and the fourth deflection patch 14 may be located on the same layer of dielectric substrate or on the different layers of the dielectric substrate based on the set position, which are not limited in the embodiment of the present application.

Wherein, the material of the fourth deflection patch 14 and the material of the third deflection patch 12 may be the same or similar. In some embodiments, the setting position of the fourth deflection patch 14 at the fourth side of the radiation patch 30 may be substantially corresponding to the setting position of the third deflection patch 12 at the third side of the radiation patch 30. This will not be repeated in the application embodiment.

For example, when the reversible switching of the crystalline state to the amorphous state of the fourth deflection patch 14 is achieved by temperature change, as shown in FIG. 17, the antenna device may further include a fourth conductive structure 15, and the location structure of the fourth conductive structure 15 may be the same or similar to that of the third conductive structure 13, which will not be repeated in the embodiment of the present application.

When the antenna device includes a third deflection patch 12, in other embodiments, when the second deflection patch 80 is fixed on the side of the second substrate layer of the dielectric substrate away from the grounding metal layer 20, the third deflection patch 12 is fixed on the side of the first substrate layer of the dielectric substrate or the third substrate layer of the dielectric substrate away from the grounded metal layer 20, and the third substrate layer of the dielectric substrate is one substrate layer of the dielectric substrate of at least one dielectric substrate 10 that is different from the first dielectric substrate and the second dielectric substrate. That is, the first deflection patch 50 and the third deflection patch 12 are located on the same substrate layer of the dielectric substrate, and the second deflection patch 80 is located on another substrate layer of the dielectric substrate; or the first deflection patch 50, the second deflection patch 80, and the third deflection patch 12 are located on the different layers of the dielectric substrate.

Alternatively, when the antenna device further includes a fourth deflection patch 14, the fourth deflection patch 14 is located on the fourth side of the radiation patch opposite to the third side of the radiation patch 30, and the fourth deflection patch 14 can be converted from the amorphous state to the crystalline state, or from the crystalline state to the amorphous state.

In some embodiments, when the third deflection patch 12 is fixed on the side of the first substrate layer of the dielectric substrate away from the grounding metal layer 20, the fourth deflection patch 14 is fixed on the side of the second substrate layer of the dielectric substrate away from the grounded metal layer 20; that is, the first deflection patch 50 and the third deflection patch 12 are located on the same substrate layer of the dielectric substrate, and the second deflection patch 80 and the fourth deflection patch 14 are located on the same substrate layer of the dielectric substrate.

In other embodiments, when the third deflection patch 12 is fixed on the side of the first substrate layer of the dielectric substrate away from the grounding metal layer 20, the fourth deflection patch 14 is fixed on the side of the first substrate layer of the dielectric substrate, the third substrate layer of the dielectric substrate, or the fourth substrate layer of the dielectric substrate away from the grounded metal layer 20, that is, the first deflection patch 50, the second deflection patch 80, and the third deflection patch 12 are located on the different layers of the dielectric substrate, and the fourth deflection patch 14 and the first deflection patch 50 are located on the same layer; or the first deflection patch 50, the second deflection patch 80, and the third deflection patch 12 are located on the different layers of the dielectric substrate, and the fourth deflection patch 14 and the third deflection patch 12 are located on the same layer; or the first deflection patch 50, the second deflection patch 80, the third deflection patch 12 and the fourth deflection patch 14 are located on the different layers of the dielectric substrate. The fourth dielectric substrate is one substrate layer of the dielectric substrate of at least one dielectric substrate 10 that is different from the first dielectric substrate, the second dielectric substrate, and the third dielectric substrate.

For example, when the antenna device includes a first deflection patch 50, a second deflection patch 80, a third deflection patch 12, and a fourth deflection patch 14, the first deflection patch 50, the second bias The sheet 80, the third deflection patch 12, the fourth deflection patch 14 and the radiation patch 30 can be fixed to the same substrate layer of the dielectric substrate, that is, the first deflection patch 50, the second deflection patch 80, the third deflection patch 12, the fourth deflection patch 14, and the radiation patch 30 may be located one the same plane, which is not limited in the embodiment of the present application.

For example, when the antenna device includes a first deflection patch 50, a second deflection patch 80, a third deflection patch 12, and a fourth deflection patch 14, any one of the first deflection patch 50, the second deflection patch 80, the third deflection patch 12, and the fourth deflection patch 14 can be controlled to change from a crystalline state to an amorphous state, or from an amorphous state to a crystalline state, so as to achieve the scanning of the radiation beam of the antenna array formed by this antenna device. The beam scanning diagram thereof may be referred to the scanning diagram when only the first deflection patch 50 and the second deflection patch 80 are included, which is not limited in the embodiment of the present application.

Illustratively, when the second feeding structure 11 feeds the excitation signal, the fourth deflection patch 14 is in a crystalline state, and the third deflection patch 12 is in an amorphous state, regardless of the state of the first deflection patch 50 and the second deflection patch 80, the main beam of the antenna is deflected in the direction of the fourth deflection patch 14. When the second feeding structure 11 feeds the excitation signal, the fourth deflection patch 14 is in an amorphous state, and the third deflection patch 12 is in a crystalline state, regardless of the state of the first deflection patch 50 and the second deflection patch 80, the main beam of the antenna is deflected in the direction of the third deflection patch 12. And, when the second feeding structure 11 feeds the excitation signal, the fourth deflection patch 14 and the third deflection patch 12 are in the same state, the main beam of the antenna is not deflected, usually in the side firing direction.

When the first feeding structure 40 feeds the excitation signal, the first deflection patch 50 is in a crystalline state, and the second deflection patch 80 is in an amorphous state, regardless of the state of the fourth deflection patch 14 and the third deflection patch 12, the main beam of the antenna is deflected in the direction of the first deflection patch 50. When the first feeding structure 40 feeds the excitation signal, the first deflection patch 50 is in an amorphous state, and the second deflection patch 80 is in a crystalline state, regardless of the state of the fourth deflection patch 14 and the third deflection patch 12, the main beam of the antenna is deflected in the direction of the second deflection patch 50. And, when the first feeding structure 40 feeds the excitation signal, the first deflection patch 50 and the second deflection patch 80 are in the same state, the main beam of the antenna is not deflected, usually in the end firing direction.

In some embodiments, the single-polarized antenna may be formed by the first feeding structure 40 and the radiation patch 30, obviously, the antenna device may further include a third feeding structure, and the third feeding structure penetrates through the dielectric substrate 10, and the first end of the third feeding structure is connected to the radiation patch 30, which defines a third connection point between the third feeding structure 40 and the radiation patch 30. The second end of the third feeding structure extends through the grounding metal layer 20, a third gap is formed between the third feeding structure and the grounding metal layer 20. The third feeding is used to feed the third excitation signal, and the third excitation signal is used to excite the radiation patch 30 to radiate beam.

In this way, when the radiation patch 30 is excited by the first excitation signal and the third excitation signal respectively fed through the first feeding structure 40 and the third feeding structure, the dual-polarized antenna can be realized, and thus the deflection of the beam radiation direction of the dual-polarized antenna can be achieved by the first deflection patch 50.

Wherein, a third connection point between the third feeding structure and the radiation patch 30 and the first connection point form center symmetry with the center point of the radiation patch 30.

In some embodiments, the single-polarized antenna may be formed by the second feeding structure 11 and the radiation patch 30, obviously, the antenna device may further include a fourth feeding structure, and the fourth feeding structure penetrates through the dielectric substrate 10, and the first end of the fourth feeding structure is connected to the radiation patch 30, which defines a fourth connection point between the fourth feeding structure 40 and the radiation patch 30. The second end of the fourth feeding structure extends through the grounding metal layer 20, and is electrically connected to the radio frequency chip 60. A fourth gap is formed between the fourth feeding structure and the grounding metal layer 20. The fourth feeding structure is used to feed the fourth excitation signal, and the fourth excitation signal is used to excite the radiation patch 30 radiation beam.

In this way, when the radiation patch 30 is excited by the second excitation signal and the fourth excitation signal respectively fed through the second feeding structure 11 and the fourth feeding structure, the dual-polarized antenna can be realized, and thus the deflection of the beam radiation direction of the dual-polarized antenna can be achieved by the third deflection patch 12 and the fourth deflection patch 14.

Wherein, the fourth connection point between the fourth feeding structure and the radiation patch 30 and the second connection point form center symmetry with the center point of the radiation patch 30.

In the embodiment of the present application, the first excitation signal and the second excitation signal can be fed through the first feeding structure and the second feeding structure respectively, and then the radiation patch can be excited by the first excitation signal and the second excitation signal to radiate the beam, so as to implement the basic function of the antenna device. Alternatively, since the first deflection patch, the second deflection patch, the third deflection patch, and the fourth deflection patch can all be converted from a crystalline state to an amorphous state, or from an amorphous state to a crystalline state, that is, the four deflection patches can all be converted from a metal state to an insulating state, or from an insulating state to a metal state, so that when the radiation patch radiation beam is excited by the first excitation signal and the second excitation signal, the first deflection patch and the second deflection patch can be controlled to be in different states, and the third deflection patch and the fourth deflection patch can be controlled to be in different states. That is, the first deflection patch can be controlled to be in the crystalline state and the second deflection patch can be controlled to be in the amorphous state, or, the first deflection patch is in the amorphous state, and the second deflection patch is in the crystalline state, and the third deflection patch can be controlled to be in the crystalline state and the fourth deflection patch can be controlled to be in the amorphous state, or the third deflection patch is in the amorphous state and the fourth deflection patch is in the crystalline state, thus achieving the adjustment of the radiation direction of the beam, improves the spatial coverage of the antenna device.

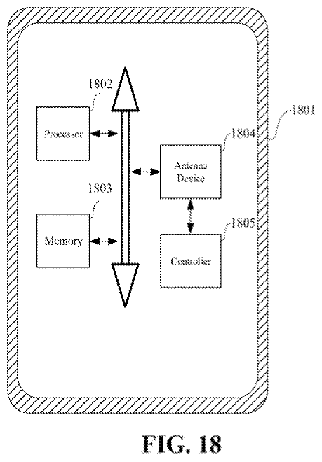

FIG. 18 illustrates a schematic structural view of an electronic device according to an embodiment of the present application. The electronic device may include the antenna device described in the above embodiments.

The electronic device may be a smart phone, a tablet computer, an MP3 player (Moving Picture Experts Group Audio Layer III, Dynamic Image Expert Compression Standard Audio 3), MP4 player (Moving Picture Experts Group Audio Layer IV, Dynamic Image Expert Compression Standard Audio 4), a laptop or a desktop computer, etc.

In some embodiments, as shown in FIG. 18, the electronic device may include a housing 1801 in which a processor 1802, a memory 1803, a controller 1804, and the antenna device 1805 of the embodiments shown in FIG. 1 to FIG. 17.

Wherein, the processor 1802 may include one or more processing cores, such as a four-core processor, eight-core processor, and so on. The memory 1803 may include one or more computer-readable storage media, which may be non-transitory. The controller 1804 is used to control the first deflection patch to be converted from an amorphous state to a crystalline state, or from a crystalline state to an amorphous state, obviously, when the antenna device includes other defection patches, the controller 1804 can also be used to control other deflection patches to be converted from an amorphous state to a crystalline state, or from a crystalline state to an amorphous state. The antenna device 1805 is used to receive electromagnetic signals, and convert them into electromagnetic wave signals to communicate with communication networks and other communication devices, or to convert the received electromagnetic wave signals into electromagnetic signals. Wherein, the electromagnetic wave signal may be millimeter wave signal or Sub-6 GHz signal, etc., which is not limited in the embodiment of the present application.

Those skilled in the art will understand that the structure shown in FIG. 18 does not constitute a limitation on the electronic device, and the electronic device may include more or fewer components than those shown in the diagram, or combine certain components, or adopt different component arrangements.

In the embodiment of the present application, since the antenna device can achieve deflection of the beam radiation direction under the action of the first deflection patch, the spatial coverage of the antenna device is improved to ensure the performance of the antenna device. In this way, it is possible to increase the spatial coverage of radiation by beam radiation in different directions of the multiple antenna devices arranged inside the electronic device, so as to improve the antenna performance of the electronic device.

The above is only an illustrative embodiment of this application and is not intended to limit this application. Any modification, equivalent replacement, improvement, etc. made within the spirit and principle of this application shall be included in the scope of protection of this application.

What is claimed is:

1. An antenna device, wherein the antenna device comprises a dielectric substrate, a grounding metal layer, a radiation patch, a first feeding structure, a first deflection patch, and a radio frequency chip;
the grounding metal layer, the dielectric substrate, and the radiation patch are stacked, the first feeding structure penetrates through the dielectric substrate, a first end of the first feeding structure is connected to the radiation patch, and a second end of the first feeding structure extends through the grounding metal layer and is electrically connected to the radio frequency chip, a first gap is formed between the first feeding structure and the grounding metal layer the radio frequency chip is configured to feed a first excitation signal to the first feeding structure to excite the radiation patch to radiate beam;
the first deflection patch is fixed on a side of dielectric substrate away from the grounding metal layer, the first deflection patch is located at a side of the radiation patch, the first deflection patch is configured to be in an amorphous state or in a crystalline state when the antenna device works.

2. The antenna device of claim 1, wherein when the first deflection patch is in the crystalline state, the beam radiated by the radiant patch is deflected to the first side of the radiation patch, and when the first deflection patch is in the amorphous state, the beam radiated by the radiant patch radiation does not deflect.

3. The antenna device of claim 1, wherein the first deflection patch is configured to be in the amorphous state or in the crystalline state by action of temperature or laser.

4. The antenna device of claim 1 further comprising a conductive structure, wherein the conductive structure penetrates through the dielectric substrate, and a first end of the first conductive structure is connected to the first deflection patch, and a second end of the conductive structure is electrically connected to an external circuit, the conductive structure is insulated from the grounding metal layer, the external circuit is configured to feed an electrical signal to the conductive structure to excite the deflection patch to change between the amorphous state and the crystalline state.

5. The antenna device of claim 1, wherein a distance between the radiation patch and the deflection patch is in a range of about 0.2 mm to about 2 mm.

6. The antenna device of claim 1 further comprising a second deflection patch, wherein the second deflection patch is fixed on the side of the dielectric substrate away from the grounding metal layer;
the second deflection patch is located at a second side of the radiation patch opposite to the side of the radiation patch where the deflection patch locates, and the second deflection patch is configured to be in an amorphous state or in a crystalline state when the antenna device works.

7. The antenna device of claim 6, wherein the dielectric substrate comprises a first substrate layer and a second substrate layer, the first deflection patch being fixed on the first substrate layer, the second deflection patch being fixed on the second substrate layer.

8. The antenna device of claim 1 further comprising a second feeding structure;
wherein the second feeding structure penetrates through the dielectric substrate, a first end of the second feeding structure is electrically connected to the radiation patch, and a second end of the second feeding structure is electrically connected to the radio frequency chip, a second gap is formed between the second feeding structure and the grounding metal layer, the radio frequency chip is further configured to feed a second excitation signal to the second feeding structure to excite the radiation patch to radiate beam.

9. The antenna device of claim 6 further comprising a third deflection patch, the third deflection patch being fixed on the side of the first substrate layer away from the grounded metal layer, or the third deflection patch being fixed on the side of the third substrate layer away from the grounded metal layer.

10. The antenna device of claim 9, wherein the third deflection patch is located on a third side of the radiation patch adjacent to the side where the first deflection patch locates, and the third deflection patch is configured to be in an amorphous state or in a crystalline state when the antenna device works.

11. The antenna device of claim 9, wherein the dielectric substrate comprises a first substrate layer, a second substrate layer and a third substrate layer, the third substrate layer being different from the first substrate layer, or second substrate layer, or both the first substrate layer and second substrate layer, the first deflection patch being fixed on the first substrate layer, the second deflection patch being fixed on the second substrate layer, the third deflection patch being fixed on the third substrate layer.

12. The antenna device of claim 9, wherein the antenna device further comprising a fourth deflection patch:
the third deflection patch being fixed on the side of the third substrate layer of the dielectric substrate away from the grounding metal layer, the fourth deflection patch being fixed on the side of the third layer of the dielectric substrate away from the grounding metal layer.

13. The antenna device of claim 12, wherein the fourth deflection patch is located on a fourth side of the radiation patch opposite to the third side, and the fourth deflection patch is configured to be in an amorphous state or in a crystalline state when the antenna device works.

14. The antenna device of claim 12, wherein the dielectric substrate comprises a first substrate layer, a second substrate layer, a third substrate layer and a fourth substrate, the fourth substrate layer being different from at least one of the first substrate layer, the second substrate layer, or the third substrate layer, the first deflection patch being fixed on the first substrate layer, the second deflection patch being fixed on the second substrate layer, the third deflection patch being fixed on the third substrate layer, the fourth deflection patch being fixed on the fourth substrate layer.

15. The antenna device of claim 1, wherein the radiation patch comprises two or more radiation sub-patches, the radiation sub-patches are stacked, and the shape and size of each radiation sub-patch are different from that of the others, or, the shape or size of each radiation sub-patch are different from that of the others.

16. The antenna device of claim 15, wherein the radiation sub-patch has a rectangular or circular structure.

17. The antenna device of claim 1, wherein the antenna device is a side-fire antenna or an end-fire antenna.

18. The antenna device of claim 1, wherein the antenna device comprises a single antenna unit or an antenna array.

19. An electronic device comprising:
a dielectric substrate, comprising a first side and a second side opposite to the first side;
a radiation patch being coupled to the first side of the dielectric substrate;
a grounding metal layer being coupled to the second side of the dielectric substrate;
a radio frequency chip, being configured to feed excitation signal via a feeding structure to excite the radiation patch to radiate beam;
a deflection patch being coupled to the first side of the dielectric substrate, the first deflection patch being located at a side of the radiation patch, the deflection patch being configured to be in an amorphous state or in a crystalline state when the antenna device works.

20. The electronic device of claim 19, the dielectric substrate comprises a plurality of substrate layers, the deflection patch comprising a plurality of deflection patches, the plurality of deflection patches are coupled to at least one of the plurality of substrate layers.
